(19) United States
(12) Patent Application Publication
(10) Pub. No.: US 2013/0032017 A1
(43) Pub. Date: Feb. 7, 2013

(54) Power Multi-Blade Ripsaw With Variably Positionable Blades

(71) Applicants: Dan V. Stocke, Sequatchie, TN (US); Louis R. Brooks, Signal Mtn., TN (US)

(72) Inventors: Dan V. Stocke, Sequatchie, TN (US); Louis R. Brooks, Signal Mtn., TN (US)

(73) Assignee: HASKO MACHINES, Soddy Daisy, TN (US)

(21) Appl. No.: 13/204,174

(22) Filed: Aug. 5, 2011

(51) Int. Cl. B27B 7/04

(52) U.S. Cl. 83/665

(57) ABSTRACT

A ripsaw includes an arbor that receives a plurality of blade assemblies each having a spindle with a saw blade affixed thereto. The blade assemblies are slidable on the arbor to any selected positions. Each blade assembly has an associated blade-positioning unit for moving the blade assembly to a desired position along the arbor. The blade-positioning units are supported by a rail assembly along which the blade-positioning units slide. The blade-positioning units are moved along the rail assembly by linear motors. A first group of the blade-positioning units has a first linear motor for moving the units of the first group, and a second group of the blade-positioning units has a second linear motor for moving the units of the second group. The two groups of blade-positioning units are interleaved on the rail assembly, and the associated blade assemblies are similarly interleaved on the arbor.

### BACKGROUND OF THE INVENTION

The present application relates to ripsaws for ripping a wide board into a plurality of narrower boards for uses such as flooring, moldings, furniture, and the like. The application more particularly relates to a power ripsaw having multiple circular saw blades (referred to herein as a “multi-blade ripsaw”) spaced apart on a common drive shaft or arbor.

Multi-blade ripsaws of the above-indicated type are commonly used for ripping wide boards into narrower boards for uses such as flooring or a host of other uses. Some multi-blade ripsaws also have the ability to variably position the saw blades at selected positions along the shaft or arbor. There are a number of basic approaches to such adjustment of the positions of saw blades. In some cases, an operator must manually adjust the saw blade positions. Manually adjustable multi-blade ripsaws can include some sort of radially expandable elements in the arbor that are controlled by a knob at the end of the arbor, the expandable elements engaging the inner surface of the central aperture in each saw blade to fix the saw blades in position. To adjust the saw blades to selected positions along the arbor, the knob is turned to retract the expandable elements, which allows the blades to be moved along the arbor to the desired positions. The knob is then turned in the opposite direction to extend the expandable elements to fix the blades in position. Alternatively, each of the blades can be connected to a collar that can be loosened on the arbor and moved to a desired position and then tightened on the arbor to fix the blade in the selected position.

Another approach to the adjustment of saw blades in multi-blade ripsaws is automated positioning through the use of either a rotary electric servomotor or the like, or a pneumatic or hydraulic cylinder arrangement. Automatically adjustable multi-blade ripsaws known to the present inventors tend to be mechanically complex and are not particularly fast at adjusting the blade positions.

### BRIEF SUMMARY OF THE INVENTION

The present disclosure describes a multi-blade ripsaw having an automated blade position adjustment system that is faster and mechanically simpler than known systems. In one embodiment as described herein, the ripsaw comprises an arbor mounted in bearings for rotation about an axis thereof, a motor and drive assembly coupled to the arbor for rotating the arbor about the axis, and a plurality of blade assemblies mounted on the arbor. Each blade assembly comprises a spindle having a saw-mounting portion, and a saw blade mounted on the saw-mounting portion. Each of the saw-mounting portions defines a central aperture for receiving and engaging the arbor in a manner permitting the spindle to slide along the arbor while preventing relative rotation between the saw-mounting portion and the arbor, so that rotation of the arbor causes the saw-mounting portions and the saw blades to be rotated. The blade assemblies can be slid to any selected positions along the arbor.

The ripsaw further comprises a blade-positioning mechanism operable to position each of the blade assemblies at a selected axial position on the arbor and hold the blade assembly in said position during sawing. The blade-positioning mechanism comprises a plurality of blade-positioning units respectively engaged with the spindles and mounted on a rail assembly extending parallel to the arbor. The blade-positioning units are movable along the rail assembly to position the respective blade assemblies at desired positions along the arbor. The blade-positioning units and respective blade assemblies are divided into a first group and a second group arranged in interleaved fashion along the rail assembly and arbor, such that a blade-positioning unit and blade assembly of the first group is followed by a blade-positioning unit and blade assembly of the second group, which is followed by a blade-positioning unit and blade assembly of the first group, and so forth.

The blade-positioning mechanism further comprises first and second linear motors respectively arranged on opposite sides of the rail assembly, each linear motor comprising a platen extending parallel to the rail assembly and a plurality of forcers movable along the platen. The forcers of the first linear motor are respectively fastened to the blade-positioning units of the first group, and the forcers of the second linear motor are respectively fastened to the blade-positioning units of the second group.

With the described blade-positioning mechanism, it is possible to make rapid adjustment of the saw blades' positions along the arbor because the linear motors are capable of high-speed movement of the forcers and thus of the blade-positioning units. Furthermore, the linear motors enable highly accurate positioning of the forcers and hence of the blade-positioning units and associated blade assemblies. The blade-positioning mechanism is mechanically much simpler than the automated blade-positioning mechanisms of which the present inventors were aware prior to the present invention.

In one embodiment, each blade-positioning unit engages the respective spindle in a releasable fashion. Each blade-positioning unit can include a user-operable engage-disengage mechanism that is movable between a spindle-engaged position in which the engage-disengage mechanism engages the spindle such that movement of the blade-positioning unit along the rail assembly causes movement of the spindle along the arbor, and a disengaged position in which the engage-disengage mechanism is disengaged from the spindle such that the spindle is movable along the arbor independently of movement of the blade-positioning unit. In a particular embodiment as described herein, each spindle defines an engagement recess in a radially outer surface of the spindle, and each engage-disengage mechanism includes a spindle-engaging portion that is engaged in the engagement recess in the spindle-engaged position and is disengaged from the engagement recess in the disengaged position. Each engage-disengage mechanism can include a detent mechanism that holds the engage-disengage mechanism in the spindle-engaged position and requires manipulation (e.g., pressing on a detent member) to allow the engage-disengage mechanism to be moved to the disengaged position.

In an exemplary embodiment, each engage-disengage mechanism has the spindle-engaging portion at one end thereof and a knob or handle on an opposite end thereof to facilitate a user grasping the knob or handle and pulling the engage-disengage mechanism so as to disengage the blade-positioning unit from the respective spindle. This engage-disengage mechanism is advantageous in that it allows a user to quickly change/replace a blade assembly without the use of hand tools.

Advantageously, one of the bearings supporting the arbor is located on one end of the arbor and is arranged to be removable and replaceable to allow blade assemblies to be slid on and off the end of the arbor for changing the blade assemblies.

Advantageously, the blade-positioning mechanism is configured such that the spindles can be positioned substantially abutting each other on the arbor so as to achieve a minimum possible spacing distance between adjacent saw blades. As an example, the blades can be spaced as close as 2.5 inches apart, although the invention is not limited to any particular spacing distance.

The rail assembly in one embodiment comprises a first rail unit on which the blade-positioning units of the first group are slidable, and a second rail unit on which the blade-positioning units of the second group are slidable. Each rail unit can comprise a pair of spaced parallel rails received through respective spaced linear bearings defined in each of the blade-positioning units of the respective group.

The arbor can be of sufficient length to accommodate any desirable number of blade-positioning units and associated blade assemblies.

Advantageously, each of the blade-positioning units is coupled to its own absolute position encoder read head that travels adjacent to a linear scale attached to the respective linear motor for the purpose of positional feed back to each linear motor controller. Unlike the standard incremental encoders most commonly used (which require a startup homing procedure), the absolute position encoders provide instant positional data when the ripsaw is started from a powered-down condition. This feature greatly reduces machine startup time.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is an isometric view of a multi-blade ripsaw in accordance with one embodiment of the invention;

FIG. 2 is a further isometric view of the ripsaw;

FIG. 3 is an isometric view of a subassembly of the ripsaw, showing the arbor, its associated motor and drive assembly, a plurality of blade assemblies mounted on the arbor, and the associated blade-positioning mechanism for the spindles;

FIG. 4 is an end view of the subassembly of FIG. 3;

FIG. 5 is an isometric view of the blade-positioning mechanism in isolation;

FIG. 6 is a top view of the blade-positioning mechanism;

FIG. 7 is a cross-sectional view along line 7-7 in FIG. 6;

FIG. 7A is a fragmentary view of a portion of FIG. 7, on an enlarged scale to better show details of the spindle construction;

FIG. 8 is an isometric view of one half of the blade-positioning mechanism, which includes one of the linear motors, the associated one of the rail units, and the associated blade-positioning units mounted on the rail unit;

FIG. 9 is an isometric view of the half of the blade-positioning mechanism of FIG. 8, generally from an opposite side thereof relative to FIG. 8; and

FIG. 10 is a cross-sectional view along line 10-10 in FIG. 6.

### DETAILED DESCRIPTION OF THE DRAWINGS

The present invention now will be described more fully hereinafter with reference to the accompanying drawings in which some but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

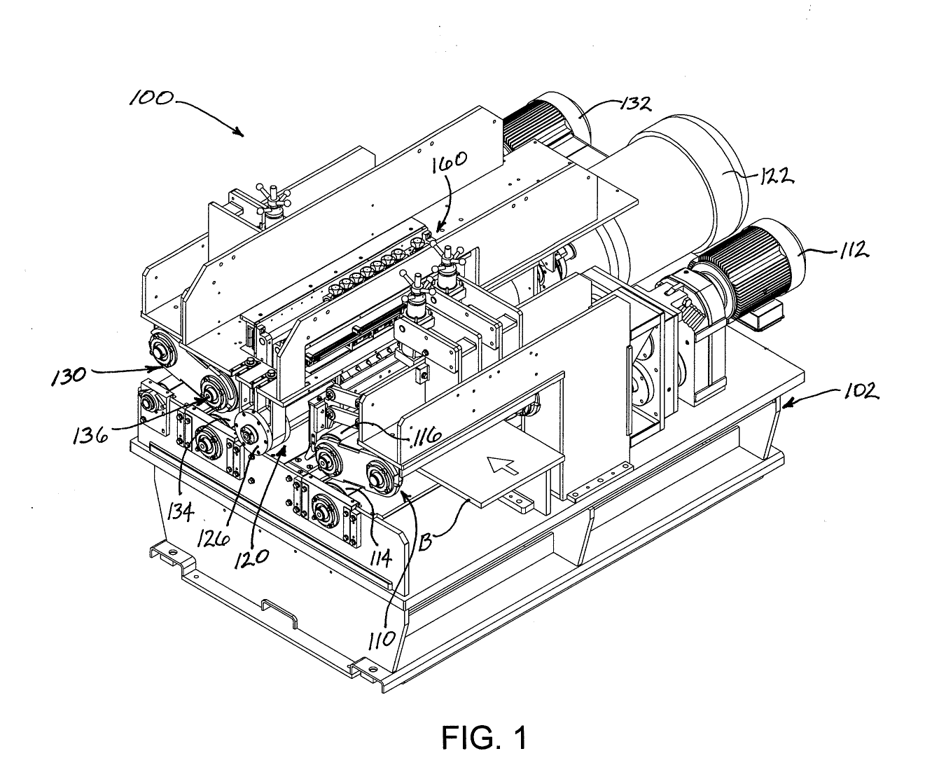

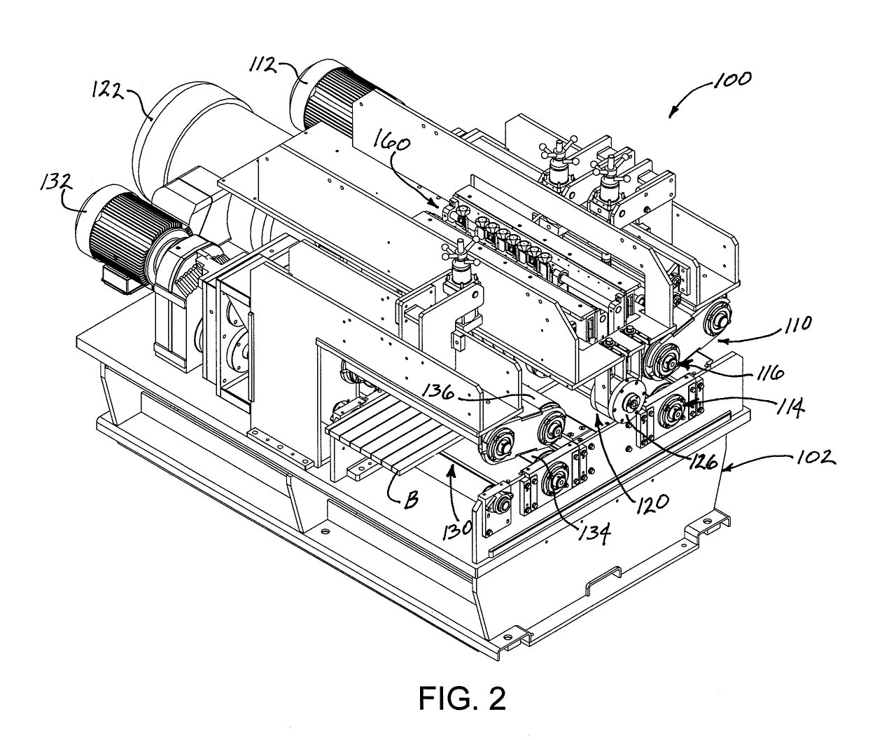

FIGS. 1 and 2 depict a multi-blade ripsaw 100 in accordance with one embodiment of the present invention. The ripsaw 100 includes a base or table 102 configured to rest upon a floor or other firm support surface, and can include provisions for the table 102 to be bolted or otherwise rigidly affixed to the floor. The table 102 supports the primary components of the ripsaw, which include an infeed unit 110, a saw unit 120, and an outfeed unit 130. The infeed unit 110 includes an infeed drive motor 112 connected through suitable drive arrangements to a bottom infeed roll 114 and a top infeed roll 116. The top infeed roll 116 is arranged above the bottom infeed roll 114 with a spacing distance between their peripheral roll surfaces, the spacing distance being approximately equal to the thickness of a board B being fed into the infeed unit. The infeed rolls 114 and 116 are driven by the infeed drive motor 112 to rotate in opposite directions about their respective axes, thereby feeding a board B into the saw unit 120 of the machine. The infeed unit includes provisions for adjusting the spacing distance between the infeed rolls so as to accommodate boards of various thicknesses. These provisions are not described herein, as persons skilled in the art will be familiar with them.

The outfeed unit 130 is generally similar to the infeed unit, and includes an outfeed drive motor 132 connected through suitable drive arrangements to a bottom outfeed roll 134 and a top outfeed roll 136. The top outfeed roll 136 is arranged above the bottom outfeed roll 134 with a spacing distance between their peripheral roll surfaces, the spacing distance being approximately equal to the thickness of a board B being fed through the outfeed unit. The outfeed rolls 134 and 136 are driven by the outfeed drive motor 132 to rotate in opposite directions about their respective axes, thereby discharging a board B that has passed through the saw unit 120 of the machine. The outfeed unit includes provisions for adjusting the spacing distance between the outfeed rolls so as to accommodate boards of various thicknesses. Again, these provisions are not described herein.

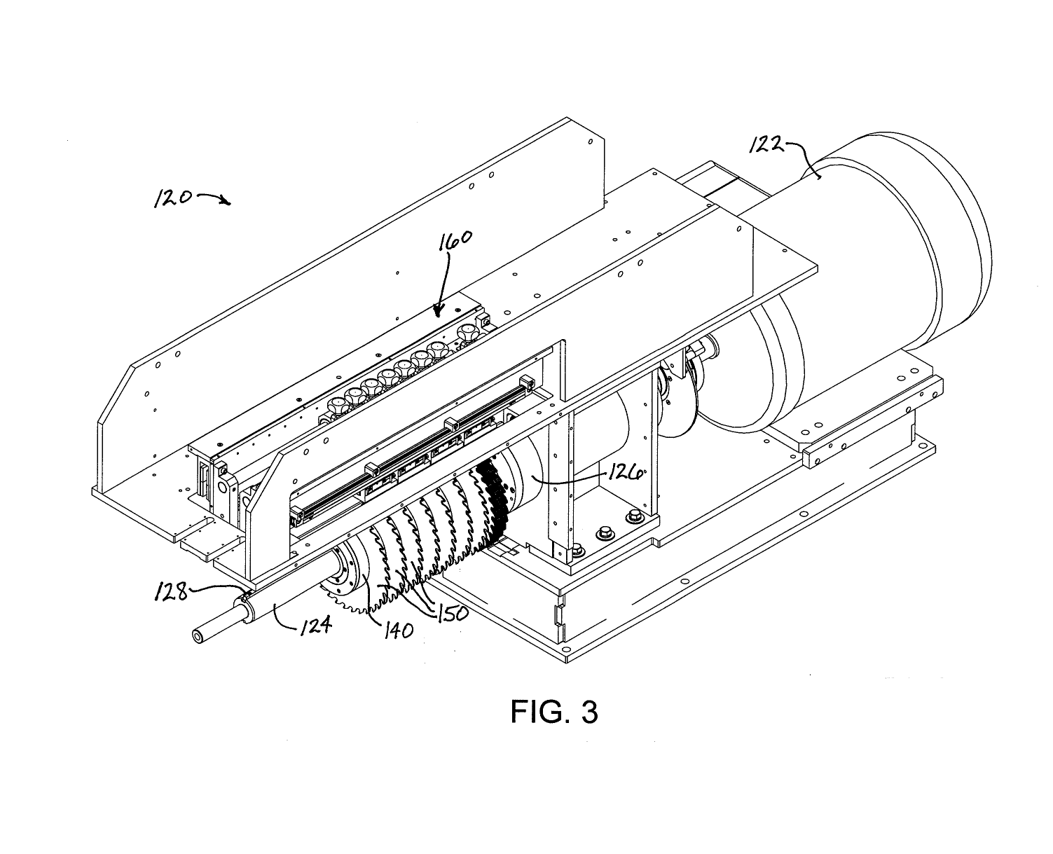

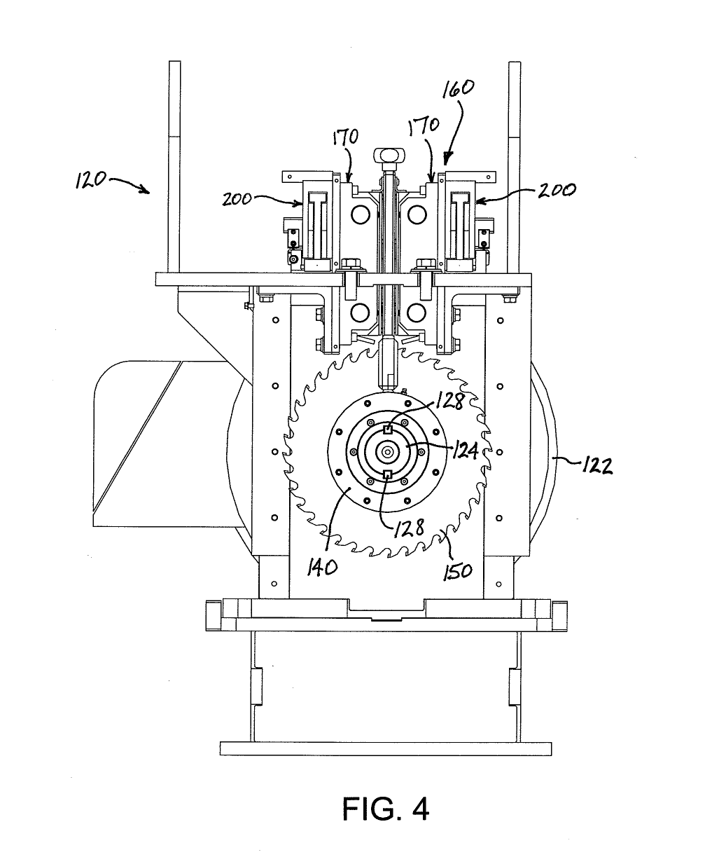

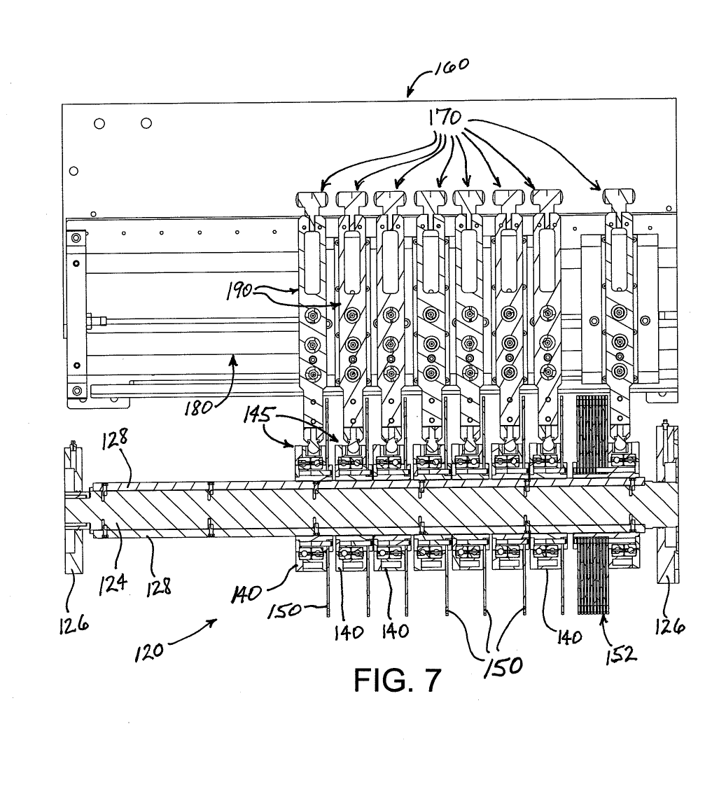

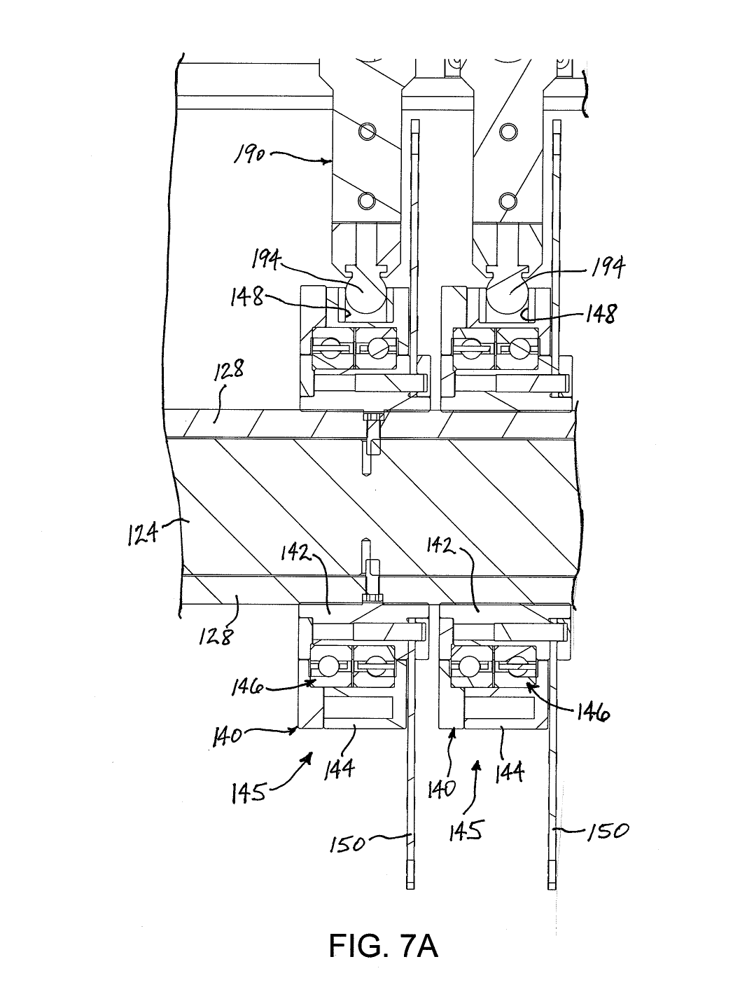

The saw unit 120 is shown in isolation in FIGS. 3 and 4. It includes a drive motor 122 connected through a suitable drive assembly to an arbor 124 so as to drive the arbor to rotate about its longitudinal axis. The arbor 124 is supported in bearings 126. One of the bearings 126 has been removed in FIGS. 3 and 4, for purposes to be described below; the removed bearing 126 can be seen in FIGS. 1 and 2. The arbor 124 includes keys 128 that project radially out from the radially outer cylindrical surface of the arbor. The saw unit includes a plurality of spindles 140 (only one of which is visible in FIGS. 3 and 4) each of which has a central aperture or bore through which the arbor 124 is received. The bore of each spindle 140 has grooves or recesses for receiving the keys 128 on the arbor, such that the spindle is prevented from rotating relative to the arbor, whereby the arbor and spindle must rotate together (see FIG. 7). While keys 128 and corresponding grooves in the spindles are described herein, it will be understood that other types of anti-rotation features could be used instead between the arbor and the spindles. Each spindle has a first axial end and an opposite second axial end. A saw blade 150 is affixed to the first axial end of each spindle 140, the spindle and saw blade thus forming a blade assembly 145 (FIG. 7A). The blade assemblies 145 are slid onto the arbor 124. It will be understood that the blade assemblies 145 can be oriented in any desired orientations, with respect to the direction that the first axial end (the end having the saw blade) of the spindle faces. For example, the blade assemblies can be oriented such that the first ends of all of the spindles face in the same axial direction, as shown in FIG. 7. Alternatively, in some cases it may be desirable to have some of spindles facing in one direction and others facing in the opposite direction. The clearance between the arbor 124 and the central apertures of the spindles 140 is such that the spindles can easily slide axially along the arbor, but the clearance is not so great as to allow the spindles to become cocked relative to the arbor. Thus, as the spindles slide relative to the arbor, they remain essentially concentric and coaxial with the arbor.

One exemplary construction of a spindle 140 is shown in FIG. 7A. Each spindle includes a saw-mounting portion 142 that defines the central aperture of the spindle through which the keyed arbor 124 is received. The saw blade 150 is affixed to this saw-mounting portion 142. The spindle also includes an outer portion, or “spindle bushing,” 144 that is not affixed to the saw blade. The spindle bushing 144 is coupled to the saw-mounting portion 142 via an intervening bearing assembly 146 that allows the spindle bushing 144 to freely rotate relative to the saw-mounting portion 142, about the same axis as that of the arbor 124. The spindle bushing 144 of the spindle defines an engagement recess 148 that is open in a radially outer direction. The engagement recess 148 points straight upward when the spindle bushing 144 of the spindle is in its correct rotational orientation. The purpose of the engagement recess 148 will be explained below.

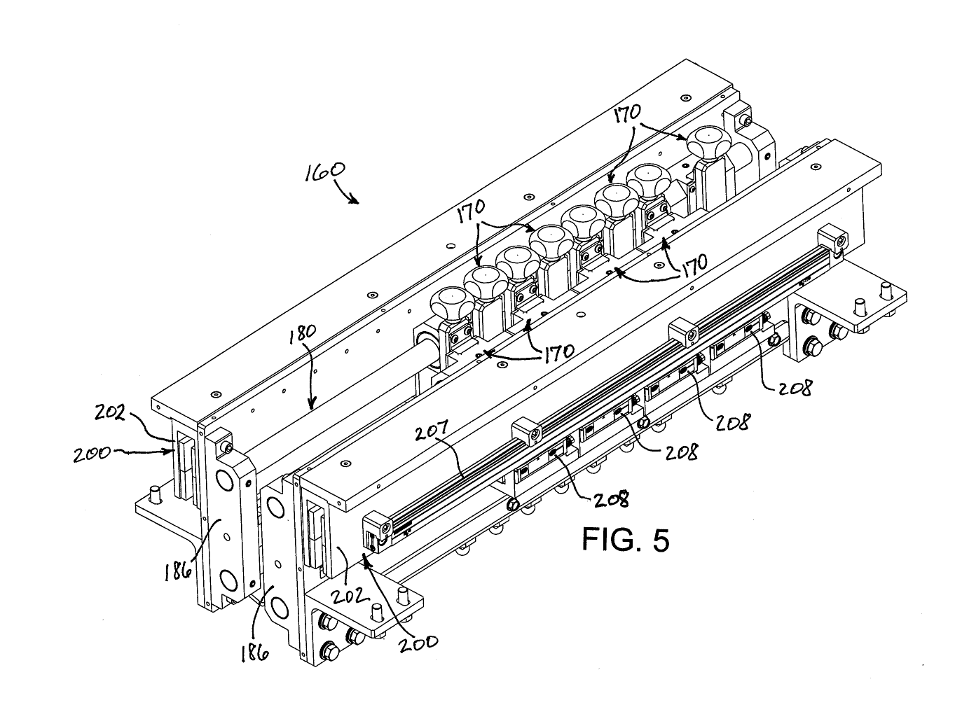

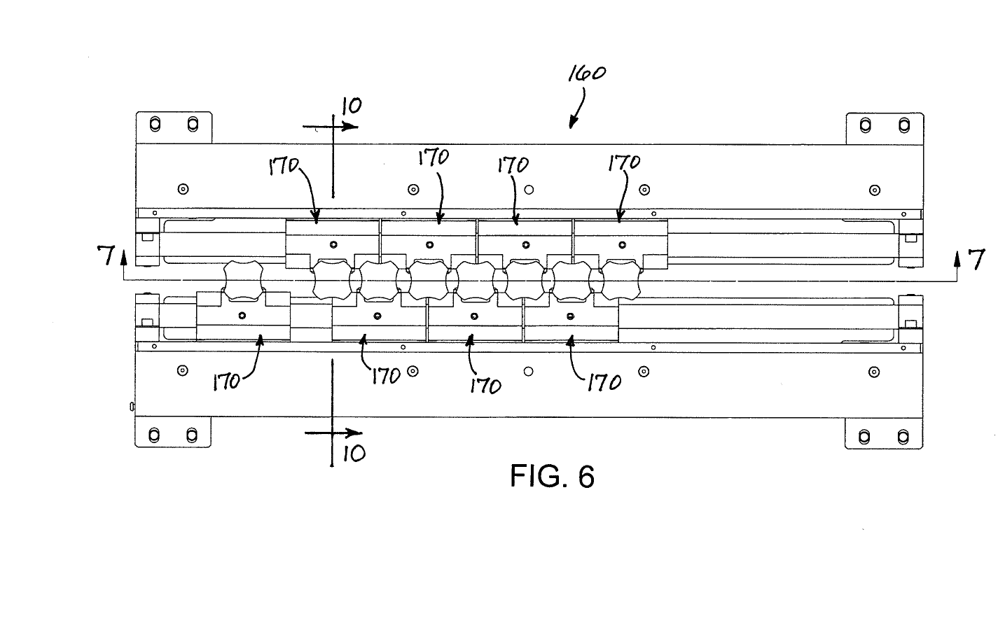

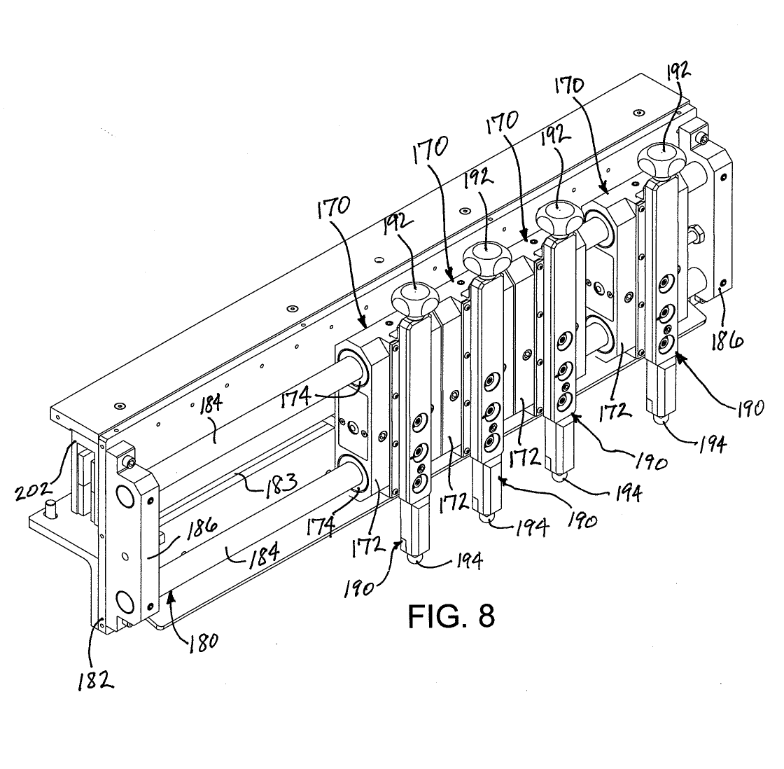

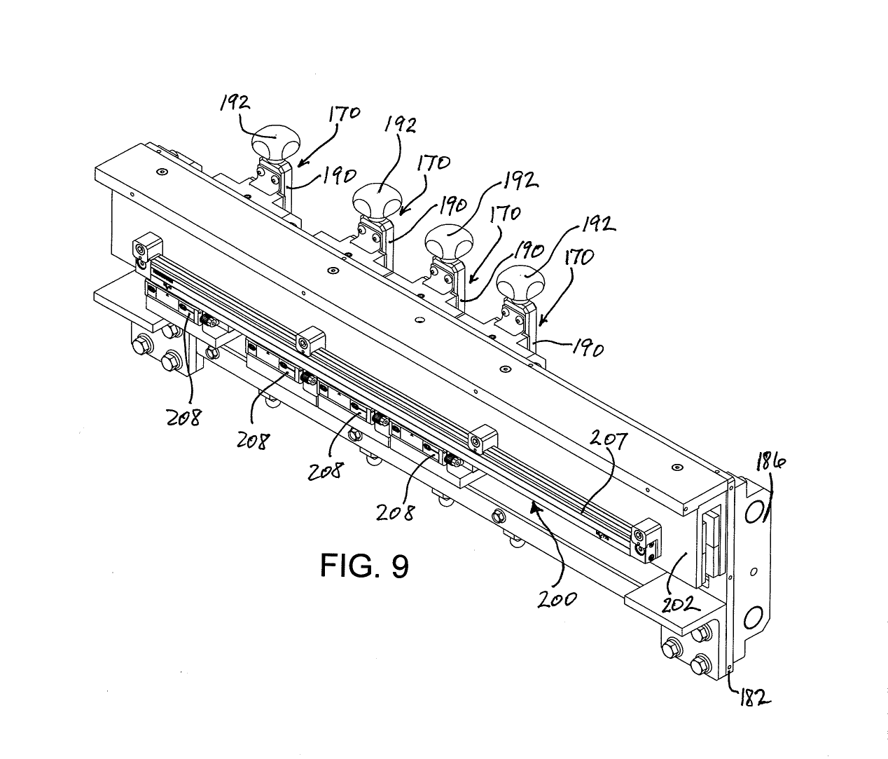

The saw unit 120 also includes a blade-positioning mechanism 160. The function of the blade-positioning mechanism 160 is to position the spindles 140 at any selected axial positions along the arbor 124, without requiring manual intervention by a person operating the ripsaw. The blade-positioning mechanism 160 is now described with reference to FIGS. 5 through 10. FIG. 5 shows an isometric view of the blade-positioning mechanism 160 in isolation, and FIG. 6 is a top view of the blade-positioning mechanism. The blade-positioning mechanism 160 comprises a plurality of blade-positioning units 170, there being one such blade-positioning unit 170 per blade assembly 145 on the arbor 124. The blade-positioning units 170 are divided into a first group of blade-positioning units 170 and a second group of blade-positioning units 170. FIG. 8 depicts one half of the blade-positioning mechanism, which includes the first group of blade-positioning units 170. As clear from FIGS. 5 and 6, the blade-positioning mechanism 160 has a second half that is essentially a mirror image of the first half and contains the second group of blade-positioning units 170. The first half will be described with reference to FIG. 8, as well as FIG. 9, which shows the first half from a rear side thereof. The second half of the mechanism will be understood to be essentially identical but mirror image to the first half.

Thus, FIG. 8 illustrates that the blade-positioning units of the first group are slidably mounted on a first rail unit 180. The rail unit 180 is affixed to one side of a vertically oriented support plate 182 that extends parallel to the arbor of the saw unit, and includes a pair of rails 184 that extend parallel to each other (and parallel to the axis of the arbor) and are vertically spaced apart. It will be understood that it is not essential that there be two rails; a single rail of appropriate configuration, or more than two rails, could be used if it were expedient to do so in a particular application. Opposite ends of the rails 184 are held in a pair of rail mounting brackets 186 affixed to the support plate 182. The blade-positioning units 170 slide along the rails 184, and thus move in a direction parallel to the axis of the arbor. Each blade-positioning unit 170 includes a carriage 172 comprising a generally rectangular prismatic body having two vertically spaced through apertures in which slide bearings 174 are held, the slide bearings 174 receiving the two rails 184 of the rail unit.

Affixed to a side of the carriage 172 facing away from the support plate 182 is a user-operable engage-disengage mechanism 190 having an axis extending perpendicular to the length directions of the rails 184 and perpendicular to the axis of the arbor. The engage-disengage mechanism 190 has an outer housing that is rigidly affixed to the carriage 172, and a slide portion that extends through a vertically extending passage defined through the outer housing. The slide portion has an upper end that projects up from the outer housing and has a knob or handle 192 affixed thereto, and has a lower end that projects down from the outer housing and defines a spindle-engaging portion 194. The knob 192 allows an operator to grasp and pull upward or push downward on the slide portion, thereby raising or lowering the spindle-engaging portion 194. The engage-disengage mechanism 190 can include a spring-loaded ball detent mechanism or the like to keep the slide portion in its lowered spindle-engaging position, such that manipulation of the detent mechanism is required in order to be able to raise the slide portion.

The spindle-engaging portion 194 of the engage-disengage mechanism is configured to be received in the engagement recess 148 of the spindle bushing 144 of the blade assembly 145 associated with the blade-positioning unit 170, as best seen in FIG. 7A. Such engagement between the blade-positioning unit 170 and the spindle bushing 144 occurs when the engage-disengage mechanism 190 is in its spindle-engaged position, i.e., when the slide portion of the engage-disengage mechanism 190 is lowered to move the spindle-engaging portion 194 into the recess 148 in the spindle bushing 144. In this condition, movement of the blade-positioning unit 170 along the rail unit 180 causes corresponding movement of the blade assembly 145 along the arbor 124.

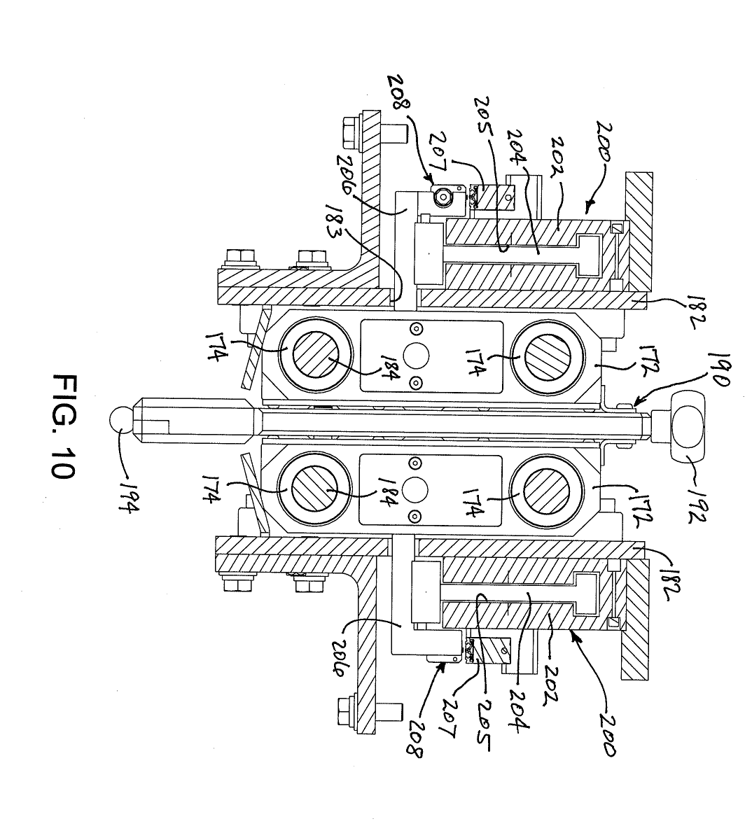

With primary reference to FIGS. 8 through 10, the provision for effecting movement of the blade-positioning units 170 is now described. A first linear motor assembly 200 is employed for moving the blade-positioning units 170 of the first group, and a second linear motor assembly 200 is employed for moving the blade-positioning units 170 of the second group (see FIG. 10). Each linear motor assembly 200 comprises a stationary linear platen 202 affixed to the opposite side of the support plate 182 from the rail unit 180, and a plurality (one per blade-positioning unit 170) of forcers 204 movable along the platen 202. The platen 202 is a generally rectangular prismatic body having a channel 205 extending down its middle, over the entire length of the platen. The channel 205 has a T-shaped cross-section as shown in FIG. 10. Each forcer 204 has a similar T-shaped cross-section of somewhat smaller dimensions than the channel 205 so that the servo readily moves in the channel in the length direction of the platen 202.

Each forcer 204 is connected, via a mounting bracket 206, to the carriage 172 of an associated one of the blade-positioning units 170. In this regard, the support plate 182 has a slot 183 extending along its length, and the mounting bracket 206 has a portion that passes through the slot 183 to connect to the carriage 172. Accordingly, as the forcer 204 is moved along the platen 202 by the linear motor's electronic controller (not shown), the blade-positioning unit 170 attached to the forcer 204 is moved along its rail unit 180.

The linear motor 200 also includes a linear encoder track 207 affixed to the platen 202 and extending parallel thereto. The mounting bracket 206 for each forcer 204 supports an absolute position encoder read head 208 for that forcer. Interaction between the encoder read head 208 and the encoder track 207 enables the linear motor's electronic controller to detect precisely where the encoder read head 208 (and, hence, the forcer 204) is located along the encoder track 207. The controller employs closed-loop control, based on signals from the encoder, to precisely position the forcer 204 at a desired location along the platen 202. Thus, each of the forcers 204, and hence their associated blade-positioning units 170, can be positioned as desired.

It will be understood that there are various linear motor technologies (e.g., brushless, brush-type, permanent magnet, induction, stepper-type, etc.) known in the art. In a preferred embodiment, each linear motor 200 comprises a brushless, cog-free linear motor in which the forcers 204 comprise primary coils and the platen 202 comprises a magnet track (secondary); however, any of the other technologies noted above can be used in embodiments of the present invention.

With reference to FIG. 5, the first group of blade-positioning units 170 is positioned by the first linear motor 200 and the second group of blade-positioning units 170 is positioned by the second linear motor 200. As best seen in FIGS. 6 and 7, the first and second groups of blade-positioning units 170 and their associated blade assemblies 145 are interleaved. That is, on the arbor 124 a blade assembly 145 associated with a first-group blade-positioning unit 170 is followed by a blade assembly 145 associated with a second-group blade-positioning unit 170, which is followed by a blade assembly 145 associated with a first-group blade-positioning unit 170, and so forth in alternating fashion along the arbor. The spindles 140 can be positioned substantially abutting each other on the arbor so as to achieve a minimum possible spacing distance between adjacent saw blades 150.

Operation of the saw unit 120 and associated blade-positioning mechanism 160 is now explained with primary reference to FIG. 7. As shown, a desired number of blade assemblies 145 have been placed onto the arbor 124, and each spindle bushing 144 has been engaged with a blade-positioning unit 170 by pulling upward on the engage-disengage mechanism 190, positioning the spindle bushing's engagement recess 148 in alignment with the engage-disengage mechanism 190 (FIG. 10), and then lowering the engage-disengage mechanism to position the spindle-engaging portion 194 in the recess 148 of the spindle bushing. The saw unit 120 is then ready for operation. The electronic controller for the linear motors 200 provides appropriate control signals to the linear motors, based on a determination made as to the desired or optimum positioning for each of the saw blades 150. The linear motors 200 thus move their forcers 204 to the commanded positions, which causes the blade-positioning units 170 to be correspondingly moved, which in turn causes the blade assemblies 145 to be moved on the arbor so as to position the saw blades as desired. The ripsaw 100 can then be operated to rip a board B into smaller-width pieces (see FIG. 2) having widths dictated by the spacings between the saw blades.

As an example, the ripsaw 100 can be equipped with a system of optical scanners (not shown) that scan an incoming board to determine its width, among other characteristics of the board. The ripsaw's controller can be programmed with logic to determine how to achieve an optimum yield from the board, given its detected width. The optimum yield may entail, for example, sawing the board into a determined number of equal-width boards, or it may entail sawing the board into a determined number of boards differing in width from one another. The controller commands the blade-positioning mechanism 160 to position the saw blades as needed in order to optimize the yield for each board fed into the ripsaw.

Boards can be fed into the ripsaw one after another, with a gap between them. An important advantage of the invention is that the time required to adjust the saw blades to new positions can be significantly shorter than has been possible with any other variably positionable ripsaw known to the inventors prior to the invention. This is due largely to the speed with which the linear motors 200 can move the blade-positioning units 170 and blade assemblies 145. As a result, when a blade position adjustment is needed between consecutive boards being fed into the ripsaw, the gap between the boards can be significantly reduced relative to what has been required with prior ripsaws.

The invention also enables blade assemblies 145 to be removed and replaced (e.g., if the blades become excessively worn, if a tooth breaks, if the blades are to be replaced by a different blade configuration, etc.) in a quick and simple manner. This is described with reference to FIGS. 1 and 3. As previously noted, one end of the arbor 124 (particularly, an end accessible to the operator) is supported in a bearing 126. The bearing 126 is configured to be readily removed, via a quick-dismount arrangement on a fixed structure of the ripsaw. FIG. 3 shows the saw unit 120 after the bearing 126 has been removed. Once the bearing has been removed, it is a simple matter to slide the blade assemblies 145 off the end of the arbor 124, after lifting up on the engage-disengage mechanisms to disengage each spindle bushing 144 from its associated blade-positioning unit. New/replacement blade assemblies 145 are then replaced on the arbor and the blade-positioning units 170 are engaged with them. Finally, the bearing 126 is replaced, and the saw unit 120 is then ready to resume operation.

The arbor 124 can be designed to accommodate any number of blade assemblies 145. As illustrated in the drawings (see particularly FIG. 7), there are seven blade assemblies 145 having regular ripsaw blades 150, plus a hogg blade 152 for removing an edge region of a board fed into the ripsaw. However, the saw unit 120 and associated blade-positioning mechanism 160 can be designed to accommodate a greater maximum number of regular saw blades (e.g., up to eight, or up to 10 or more). There is no theoretical limit to the maximum number of blades.

Many modifications and other embodiments of the inventions set forth herein will come to mind to one skilled in the art to which these inventions pertain having the benefit of the teachings presented in the foregoing descriptions and the associated drawings. For example, the spindles 140 described herein have a construction in which the saw-mounting portion 142 rotates with the arbor while the spindle-bushing 144 does not rotate. This construction allows the spindle-engaging portion 194 of the engage-disengage mechanism 190 to be a simple fixed structure. Alternatively, however, it is within the scope of the invention to employ a simpler spindle construction in which the entire spindle rotates with the arbor and defines a circular track in which the spindle-engaging portion of the engage-disengage mechanism rides as the spindle rotates with the arbor. In this case, it may be necessary or desirable to construct the spindle-engaging portion to be rotatable, and/or it may be necessary or desirable to provide a low-friction coating on the circular track of the spindle and/or on the spindle-engaging portion. Accordingly, references herein to a blade-positioning unit 170 being engaged with a “spindle” will be understood to mean any suitable engagement that allows the saw-mounting portion of the spindle (whether the saw-mounting portion makes up only part of the spindle or all of the spindle) to rotate with the arbor while the blade-positioning unit is engaged with the spindle. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A ripsaw with variably positionable blades for ripping boards to various widths, comprising:
an arbor mounted in bearings for rotation about an axis thereof, and a motor and drive assembly coupled to the arbor for rotating the arbor about the axis;
a plurality of blade assemblies each comprising a spindle and a saw blade mounted on a saw-mounting portion of the spindle, each saw-mounting portion having a central aperture for receiving the arbor, the blade assemblies being slidable along the arbor to any selected positions therealong, the arbor and saw-mounting portions of the spindles having cooperative anti-rotation features such that the saw-mounting portions rotate with the arbor and relative rotation between the saw-mounting portions and the arbor is prevented; and
a blade-positioning mechanism operable to position each of the blade assemblies at a selected axial position on the arbor and hold the blade assembly in said position during sawing, the blade-positioning mechanism comprising:
a plurality of blade-positioning units respectively engaged with the spindles of the blade assemblies and mounted on a rail assembly extending parallel to the arbor, the blade-positioning units being movable along the rail assembly to position the respective blade assemblies at desired positions along the arbor, the blade-positioning units and respective blade assemblies being divided into a first group and a second group arranged in interleaved fashion such that a blade-positioning unit and blade assembly of the first group is followed by a blade-positioning unit and blade assembly of the second group, which is followed by a blade-positioning unit and blade assembly of the first group, and so forth; and
first and second linear motors respectively arranged on opposite sides of the rail assembly, each linear motor comprising a platen extending parallel to the rail assembly and a plurality of forcers movable along the platen, wherein the forcers of the first linear motor are respectively fastened to the blade-positioning units of the first group, and the forcers of the second linear motor are respectively fastened to the blade-positioning units of the second group.

2. The ripsaw of claim 1, wherein each blade-positioning unit engages the respective spindle in a releasable fashion.

3. The ripsaw of claim 2, wherein each blade-positioning unit includes a user-operable engage-disengage mechanism that is movable between a spindle-engaged position in which the engage-disengage mechanism engages the spindle such that movement of the blade-positioning unit along the rail assembly causes movement of the spindle along the arbor, and a disengaged position in which the engage-disengage mechanism is disengaged from the spindle such that the spindle is movable along the arbor independently of movement of the blade-positioning unit.

4. The ripsaw of claim 3, wherein each spindle defines an engagement recess in a radially outer surface of the spindle, and each engage-disengage mechanism includes a spindle-engaging portion that is engaged in the engagement recess in the spindle-engaged position and is disengaged from the engagement recess in the disengaged position.

5. The ripsaw of claim 4, wherein each engage-disengage mechanism includes a detent mechanism for holding the engage-disengage mechanism in the spindle-engaged position.

6. The ripsaw of claim 5, wherein each engage-disengage mechanism has the spindle-engaging portion at one end thereof and a knob or handle on an opposite end thereof to facilitate a user grasping the knob or handle and pulling the engage-disengage mechanism so as to disengage the blade-positioning unit from the respective spindle.

7. The ripsaw of claim 1, wherein one of the bearings supporting the arbor is located on one end of the arbor and is arranged to be removable and replaceable to allow blade assemblies to be slid on and off the end of the arbor for changing blade assemblies.

8. The ripsaw of claim 1, wherein the spindles can be positioned substantially abutting each other on the arbor so as to achieve a minimum possible spacing distance between adjacent saw blades.

9. The ripsaw of claim 8, wherein the axial length of the blade-positioning units does not exceed about 5 inches.

10. The ripsaw of claim 1, wherein the rail assembly comprises a first rail unit on which the blade-positioning units of the first group are slidable, and a second rail unit on which the blade-positioning units of the second group are slidable.

11. A ripsaw with variably positionable blades for ripping boards to various widths, comprising:
an arbor mounted in bearings for rotation about an axis thereof, and a motor and drive assembly coupled to the arbor for rotating the arbor about the axis;
a plurality of blade assemblies each comprising a spindle and a saw blade mounted on a saw-mounting portion of the spindle, each saw-mounting portion having a central aperture for receiving the arbor, the blade assemblies being slidable along the arbor to any selected positions therealong, the arbor and saw-mounting portions of the spindles having cooperative anti-rotation features such that the saw-mounting portions rotate with the arbor and relative rotation between the saw-mounting portions and the arbor is prevented; and
a linear motor assembly having at least one platen and a plurality of forcers movable along the at least one platen, each forcer being coupled with a respective one of the blade assemblies such that movement of the forcer along the at least one platen causes movement of the blade assembly along the arbor, the linear motor assembly being operable to move the forcers to predetermined positions along the at least one platen so as to position the blade assemblies in predetermined positions on the arbor.

12. The ripsaw of claim 11, wherein the linear motor assembly comprises a brushless linear motor assembly, the at least one platen comprising a magnet track and the forcers comprising primary coils.

13. The ripsaw of claim 11, wherein the forcers are coupled to the blade assemblies by way of blade-positioning units, each blade-positioning unit being affixed to a respective one of the forcers and being engaged with a respective one of the blade assemblies.

14. The ripsaw of claim 13, wherein each blade-positioning unit is selectively engageable with and disengageable from the respective blade assembly.

15. The ripsaw of claim 14, wherein one of the bearings supporting the arbor is located on one end of the arbor and is arranged to be removable and replaceable to allow blade assemblies to be slid on and off the end of the arbor for changing blade assemblies.

16. The ripsaw of claim 13, wherein each of the blade-positioning units is coupled to an absolute position encoder read head, and the linear motor includes a linear encoder scale located such that the encoder read heads of the blade-positioning units travel adjacent to the linear encoder scale, the encoder read heads providing absolute position for each of the blade-positioning units.
